(19) United States
(12) Patent Application Publication
(10) Pub. No.: US 2024/0131512 A1
(43) Pub. Date: Apr. 25, 2024

(54) MODULAR ANALYTE SENSING SYSTEM

(71) Applicant: PROBIUSDX, INC., Fremont, CA (US)

(72) Inventors: Jeremy Hui, Newark, CA (US); Sean Fischer, Mountain View, CA (US); Emmanuel Philippe Quevy, El Cerrito, CA (US); Zheng Jia, Fremont, CA (US); Chaitanya Gupta, San Carlos, CA (US)

(21) Appl. No.: 18/488,569

(22) Filed: Oct. 16, 2023

Related U.S. Application Data
(60) Provisional application No. 63/380,550, filed on Oct. 21, 2022.

(51) Int. Cl. B01L 3/00

(52) U.S. Cl. CPC B01L 3/502715; B01L 2200/04; B01L 2200/10; B01L 2300/021; B01L 2300/023; B01L 2300/0645; B01L 2300/0663

(57) ABSTRACT

A removable cartridge is configured to receive one or more fluid sample for analysis. The cartridge includes multiple sample wells. Each of the sample wells includes a sensor with a first electrode, a second electrode, and a third electrode. The electrodes are arranged to contact the sample fluid. A base is configured to receive the cartridge. The base is configured to send and receive signals to the cartridge when the cartridge is received by the base. A controller is configured to exchange signals with the first electrode, the second electrode, and the third electrode. The controller configured to identify each sample well of the cartridge. The controller is configured to determine a status of each sample well of the cartridge. The controller is configured to perform an analysis of a substance within at least one of the sample wells.

### CROSS-REFERENCE TO RELATED APPLICATIONS

This application claims benefit of priority to U.S. Provisional Application No. 63/380,550, filed 21 Oct. 2022, the contents of which is hereby incorporated by reference in its entirety.

### TECHNICAL FIELD

The present disclosure relates generally to devices and methods useful for detection of analytes within fluid samples.

### BACKGROUND

Traditional methods of bioanalysis include preparation of a sample including a target analyte and analyzing the analytes using analyte-specific chemistries (e.g., detect the analyte by attaching to the analyte). The preparation of the sample can include stripping the biological matrix of the sample from the analyte to be detected to present a “clean” sample for detection. The detection can be performed by the sensor including a physical transducer that converts information about the presence of the analyte to a measurable signal (either via the intermediate binding step or directly as done in mass spectrometry). The interaction of the transducer with the to-be-detected analyte can require intermediate cleaning steps to ensure there is no interference in the transducer signal from other biological species in the stripped-down and sample-prepared matrix.

The traditional approach can require target-specific chemicals, biological reagents and cleaning steps to be incorporated as part of a multi-step protocol in the detection of analytes. The use of these target-specific chemicals, biological reagents and cleaning steps also necessitates a-priori hypothesis/knowledge of the target that will be detected as part of the workflow. Furthermore, each time a new analyte in the sample needs to be analyzed, the sample may need to be prepared again. As a result, traditional methods of bioanalysis can be cumbersome, inefficient and expensive.

### SUMMARY

This disclosure relates to technologies involving a modular analyte sensing system.

One example implementation of the subject matter described within this disclosure is an analyte sensing system with the following features. A removable cartridge includes sample wells. Each sample well is configured to receive a sample fluid for analysis. A base is configured to receive the cartridge. The base is configured to send and receive signals to the cartridge when the cartridge is received by the base.

Aspects of the example analyte sensing system, that can be combined with the example analyte system alone or in combination with other aspects, include the following. Each of the sample wells includes a sensor with the following features. A first electrode is arranged to contact the sample fluid. A second electrode is arranged to contact the sample fluid. A third electrode is arranged to contact the sample fluid.

Aspects of the example analyte sensing system, that can be combined with the example analyte system alone or in combination with other aspects, include the following. The base includes the following features. A receptacle is configured to receive electrical pins coupled to the first electrode, the second electrode, and the third electrode. A controller is coupled to the receptacle. The controller is configured to direct an exchange of signals with the first electrode, the second electrode, and the third electrode by the receptacle and pins.

Aspects of the example analyte sensing system, that can be combined with the example analyte system alone or in combination with other aspects, include the following. The controller is configured to identify each sample well of the cartridge. The controller is configured to determine a status of each sample well of the cartridge. The controller is configured to direct an analysis of a substance to be performed within at least one of the sample wells. The controller is configured to produce a spectrum based on the performed analysis.

Aspects of the example analyte sensing system, that can be combined with the example analyte system alone or in combination with other aspects, include the following. The controller is further configured to determine a presence of a target analyte based on the produced spectrum.

Aspects of the example analyte sensing system, that can be combined with the example analyte system alone or in combination with other aspects, include the following. The controller is further configured to upload the produced spectrum to a cloud service.

Aspects of the example analyte sensing system, that can be combined with the example analyte system alone or in combination with other aspects, include the following. The cartridge includes a rocking linkage configured to separate the cartridge from the base.

An example implementation of the subject matter described within this disclosure is a method with the following features. A removable cartridge is received by a base. The cartridge includes multiple sample wells. Each sample well of the cartridge is identified. A status of each sample well of the cartridge is determined. An analysis of a substance is performed within at least one of the sample wells. A spectrum is produced based on the performed analysis.

Aspects of the example method, that can be combined with the example method alone or in combination with other aspects, include the following. Determining the status can include the following. An identification of the sample well is determined. A usage history of the sample well is looked-up. A fit-for-use status of the sample well is determined.

Aspects of the example method, that can be combined with the example method alone or in combination with other aspects, include the following. The fit-for-use status is determined based on at least the following criteria: a date when the sample well was last used and a date when the sample well was last serviced.

Aspects of the example method, that can be combined with the example method alone or in combination with other aspects, include the following. Looking-up a usage history includes querying a look-up table.

Aspects of the example method, that can be combined with the example method alone or in combination with other aspects, include the following. The fit-for-use status indicates that the sample well is not usable. In such instances, the sample well is locked-out from analysis operations.

Aspects of the example method, that can be combined with the example method alone or in combination with other aspects, include the following. The fit-for-use status indicates that the sample well is usable. In such instances, the sample well is enabled for analysis operations.

Aspects of the example method, that can be combined with the example method alone or in combination with other aspects, include the following. The cartridge is serviced.

Aspects of the example method, that can be combined with the example method alone or in combination with other aspects, include the following. Servicing the cartridge includes replacing the plurality of sample wells or cleaning the sample wells.

Aspects of the example method, that can be combined with the example method alone or in combination with other aspects, include the following. A presence of a target analyte is determined based on the produced spectrum.

Aspects of the example method, that can be combined with the example method alone or in combination with other aspects, include the following. Determining a presence of a target analyte based on the produced spectrum includes the following. A reference spectrum is generated from a reference sample. The produced spectrum is compared against the reference spectrum.

Aspects of the example method, that can be combined with the example method alone or in combination with other aspects, include the following. The produced spectrum is uploaded to a cloud service.

An example implementation of the subject matter descried within this disclosure is an analyte sensing system with the following features. A removable cartridge is configured to receive one or more fluid sample for analysis. The cartridge includes multiple sample wells. Each of the sample wells includes a sensor with a first electrode, a second electrode, and a third electrode. The electrodes are arranged to contact the sample fluid. A base is configured to receive the cartridge. The base is configured to send and receive signals to the cartridge when the cartridge is received by the base. The base includes the following features. A receptacle is configured to receive electrical pins coupled to the first electrode, the second electrode, and the third electrode. A controller is coupled to the receptacle. The controller is configured to direct and exchange signals with the first electrode, the second electrode, and the third electrode by the receptacle and the pins. The controller configured to identify each sample well of the cartridge. The controller is configured to determine a status of each sample well of the cartridge. The controller is configured to direct an analysis of a substance within at least one of the sample wells to be performed. The controller is configured to produce a spectrum based on the performed analysis. The controller is configured to determining a presence of a target analyte based on the produced spectrum.

Aspects of the example analyte sensing system, which can be combined with the example analyte sensing system alone or in combination with other aspects, includes the following. The controller is further configured to upload the produced spectrum to a cloud service.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The foregoing summary is illustrative only and is not intended to be in any way limiting. In addition to the illustrative embodiments and features described herein, further aspects, embodiments, objects and features of the disclosure will become fully apparent from the drawings and the detailed description and the claims.

### BRIEF DESCRIPTION OF THE FIGURES

These and other features will be more readily understood from the following detailed description taken in conjunction with the accompanying drawings, in which:

FIG. 1 is a perspective view of an example modular analyte system fully assembled.

FIG. 2 is a perspective view of an example modular analyte system with a cartridge removed from a base.

FIG. 3 is a perspective view of an example modular analyte system base.

FIG. 4A is a top perspective view of an example modular analyte system cartridge.

FIG. 4B is a perspective views of internals of the analyte system.

FIG. 5 is a bottom-up view of an example modular analyte system cartridge.

FIG. 6 is a bottom perspective view of an example modular analyte system cartridge.

FIG. 7 is a side perspective view of an example modular analyte system cartridge.

FIG. 8 is a top perspective view of an example sample well.

FIG. 9 is a bottom perspective view of an example well with a single sensor.

FIG. 10 is a bottom perspective view of an example well with multiple sensors.

FIG. 11 is a diagram showing the communications between the modular analyte system, a cloud service, and a local computer.

FIG. 12 is a block diagram of an example controller that can be used with aspects of this disclosure.

FIG. 13 is a flowchart of an example method that can be used with aspects of this disclosure.

### DETAILED DESCRIPTION

The present disclosure generally relates to, characterizing samples (e.g., electrochemical solution including analytes and redox species). The method for characterizing the biological sample can include a workflow that is universal (e.g., not specific to a give analyte due to analyte-specific chemistry) and simplified (e.g., does not require extensive sample preparation). In some implementations, the method relies on a biological sample measurement method (e.g., by a sensor platform including a consumable and an instrument) and machine-learning (ML) enabled data analysis stack, where the appropriate analysis can be customized from a suite of available ML models, to predict the sample phenotype or the quantitation of specific biological characteristics, including biomarkers with a high degree of sensitivity and specificity.

The present disclosure describes an analyte sensing system with a removable cartridge that include multiple sample wells configured to receive a sample fluid for analysis. A base is configured to receive the cartridge. The base is configured to send and receive signals to the cartridge when the cartridge is received by the base. In some implementations, the base can additionally communicate (exchange information between) itself and a computer, cloud service, or both.

An assay is described as a process of assigning a phenotype class to a sample or assessing the expression/concentration of one or more analytes in a sample. In some implementations, the system (or sensor platform) for performing the assay can include three elements: the consumable, the instrument and one or more computing systems for executing feature-set extraction (e.g., from raw data acquired by consumable/instrument detection) and analysis software stack.

Each element of the system could have multiple implementations. Each implementation can be informed by customer workflows and the sample type being analyzed. For example, selection of a particular implementation can require assessment of trade-off between throughput, power, footprint and desired noise power-spectral-density (PSD) performance. In some implementations, the consumable and/or instrument can be modified to tailor to specific applications.

The consumable can include a sensor with an interface geometry configured to interface with the sample including the analyte. The interface geometry can include nanoscale electrochemical interface described in U.S. patent application Ser. No. 16/016,468, U.S. patent application Ser. No. 17/317,422, and U.S. Pat. No. 9,285,336 which have been incorporated herein by reference in their entirety. The consumable can be integrated with a sample collection mechanism (e.g., syringe, pipette, breath analyzer). Alternately, the consumables can be integrated with a sample storage device (e.g., storage cap, vial/test tube, vacutainer, beaker, dried spot card, microtiter plate, culture/other flask, μfluidic cartridge, etc.). In some implementations, the consumable and/or the instrument can be integrated with sample handling robots. The instrument can be integrated with the consumable (e.g., can be configured to receive an electric signal indicative of detection by the consumable). The instrument can have a low throughput (e.g., single consumable read), a medium throughput (e.g., 6 consumable read) or a high throughput (e.g., 24-1536 consumable read). The medium and high throughput instruments can perform multiple readouts/scan of samples in multiple consumables.

The computation of raw data acquired by the instrument (e.g., using a Machine Learning model) can be executed locally (e.g., local compute) or on a cloud (cloud compute). The determination of whether to perform the computation locally, on a cloud or a combination thereof can be based on internet connectivity, need to preserve data security and/or quick time to result.

In the following detailed description, reference is made to the accompanying drawings, which form a part hereof. In the drawings, similar symbols generally identify similar components, unless context dictates otherwise. The illustrative alternatives described in the detailed description, drawings, and claims are not meant to be limiting. Other alternatives may be used and other changes may be made without departing from the spirit or scope of the subject matter presented here. It will be readily understood that the aspects, as generally described herein, and illustrated in the Figures, can be arranged, substituted, combined, and designed in a wide variety of different configurations, all of which are explicitly contemplated and make part of this application.

Unless otherwise defined, all terms of art, notations, and other scientific terms or terminology used herein are intended to have the meanings commonly understood by those of skill in the art to which this application pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

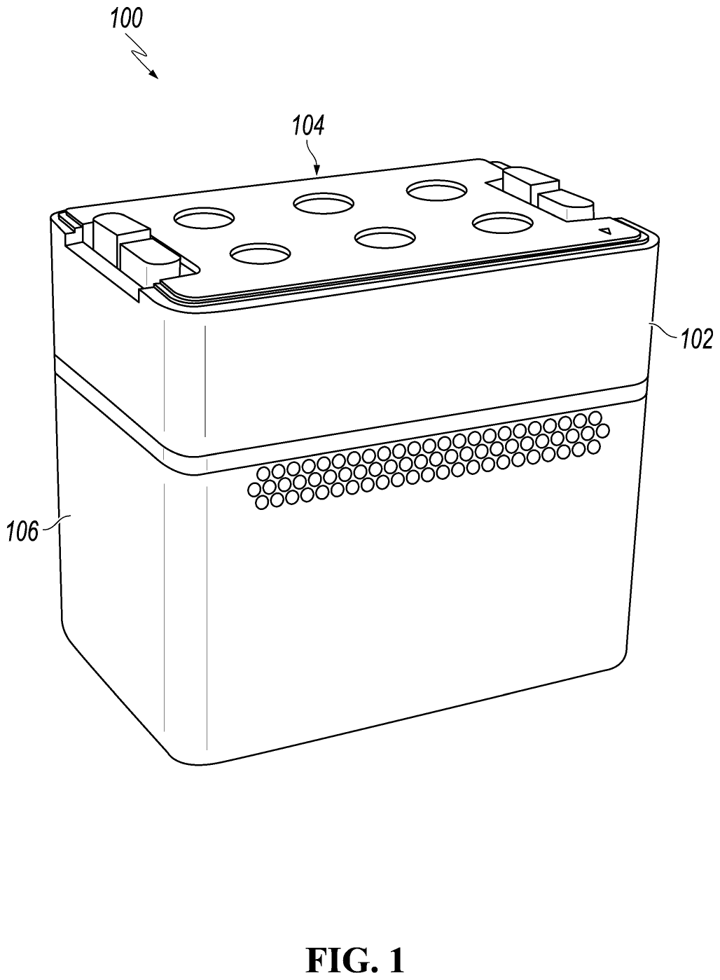

FIG. 1 is a perspective view of an example modular analyte system 100 assembled. The system 100 includes a removable cartridge 102 with one or more sample wells 104. Each of the sample wells 104 is configured to receive a sample fluid for analysis. A base 106 configured to receive the cartridge. The base 106 is configured to send and receive signals to the cartridge 102 when the cartridge 102 is received by the base 106.

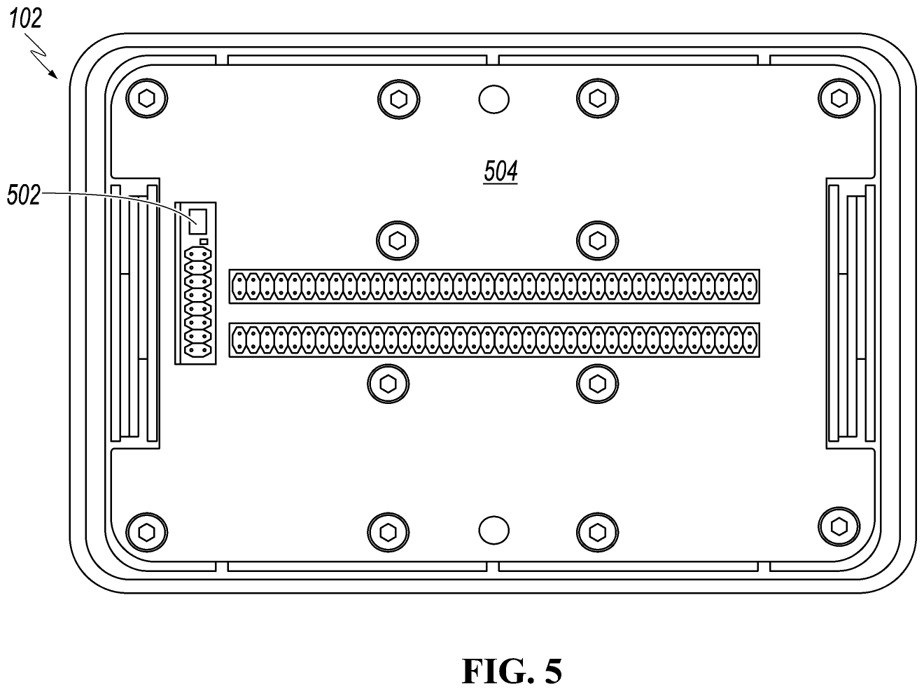

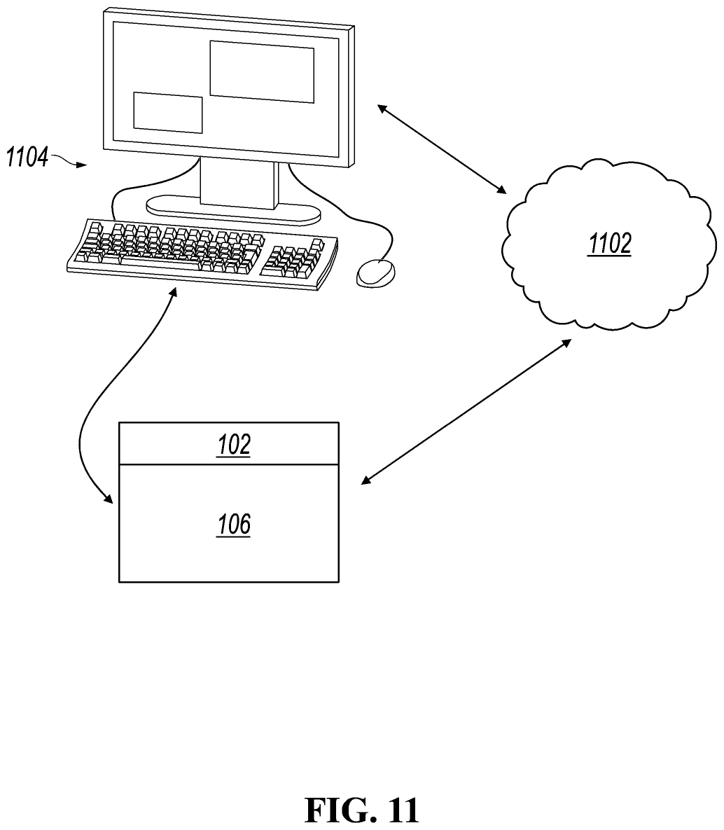

Focusing on the cartridge 102, in some implementations, the cartridge 102 is a standalone plug-in into which the user can place received individual wells 104 and affix the wells 104 to the cartridge 102 using a locking mechanism (not shown). Each well can be tagged with an identifier, such as a barcode, radio frequency identification (RFID), and/or another identifier. In such an implementation, the identifier is configured to transmit a unique well ID to a cloud gateway 1102 (FIG. 11). More details on such operations are explained throughout this disclosure. In some implementations, the well IDs are already written to a cartridge memory 502 (FIG. 5) during manufacturing and assembly of the cartridge 102. In such implementations, the user receives the cartridge 102 with the wells 104 already loaded and secured within the cartridge 102.

In some implementation, the wells 104 are shipped as individual units to the user. In such implementations, the user loads the wells into the cartridge 102, uses wells 104 for sample measurement, and then discards used wells 104. That is, in such an implementation, the wells 104 are a disposable, single use item. In some implementation, the cartridge 102 is shipped with the wells 104 already integrated. In such implementations, the user can empty the wells 104 of all liquid electrolyte and samples, then ship the emptied cartridge back to a manufacturer or service provider to service the cartridge 102. In some implementations, the wells 104 are replaced during such a service.

The base 106 is sanctioned and provisioned as part of the manufacturing to make the base 106 and/or cartridge 102 available to designated users via the cloud service. The provisioning and sanctioning also creates secure communication ports between the modular analyte system 100 and a cloud service 1102 (FIG. 11).

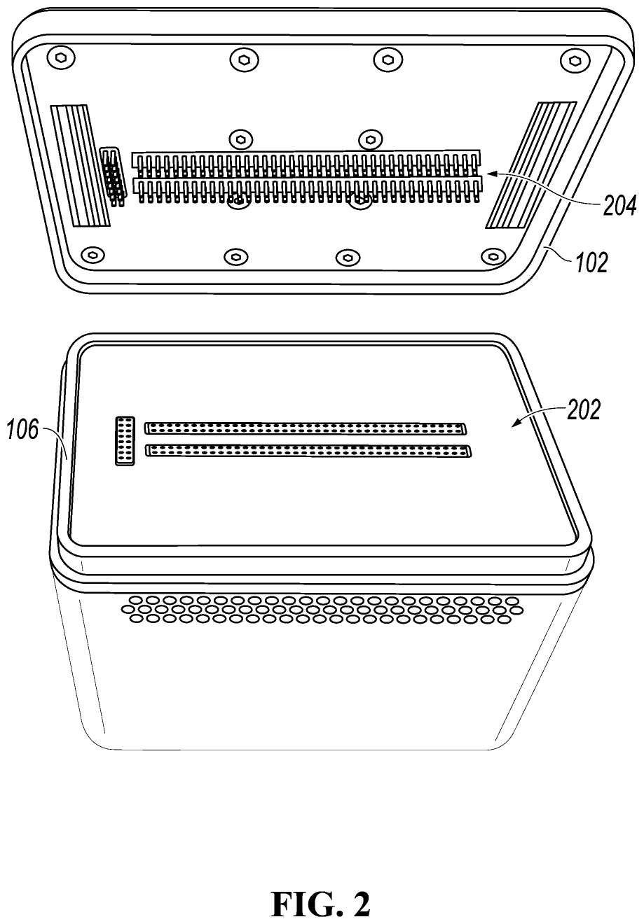

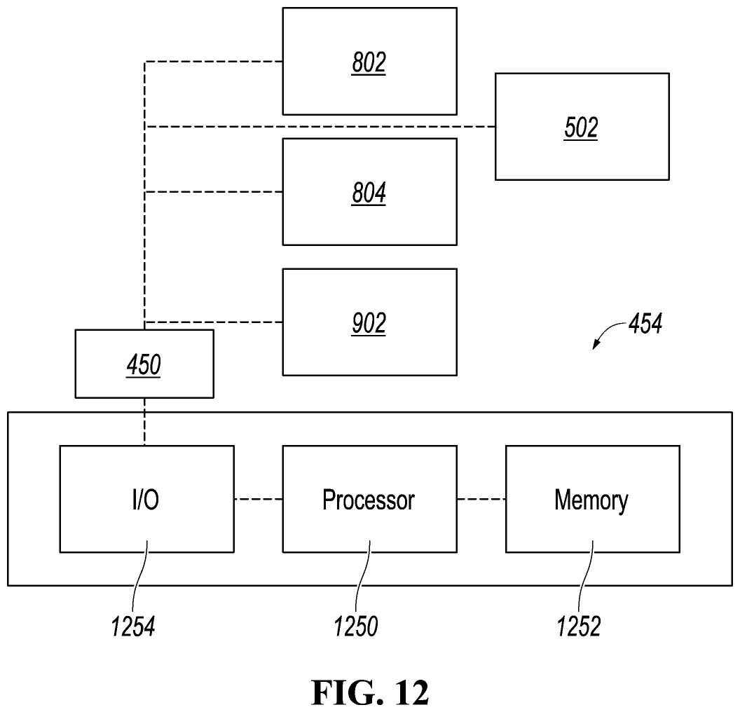

FIG. 2 is a perspective view of an example modular analyte system 100 with a cartridge 102 removed from a base 106. As illustrated, the base 106 includes a receptacle 202 configured to receive Electrical pins 204 of the cartridge 102. Some of these electrical pins are coupled to the electrodes (902, 802, 804). The receptacle is coupled to a controller (FIG. 12) configured to exchange signals with the cartridge by the receptacle 202 and pins 204.

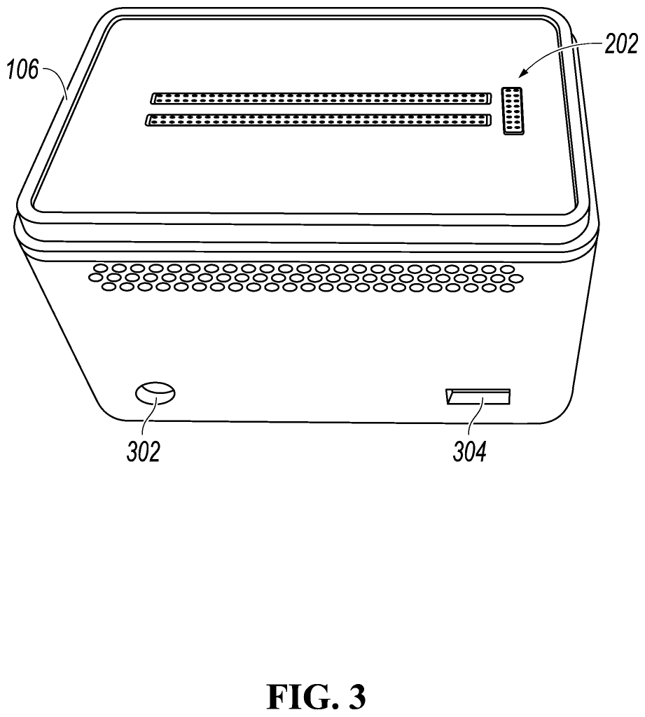

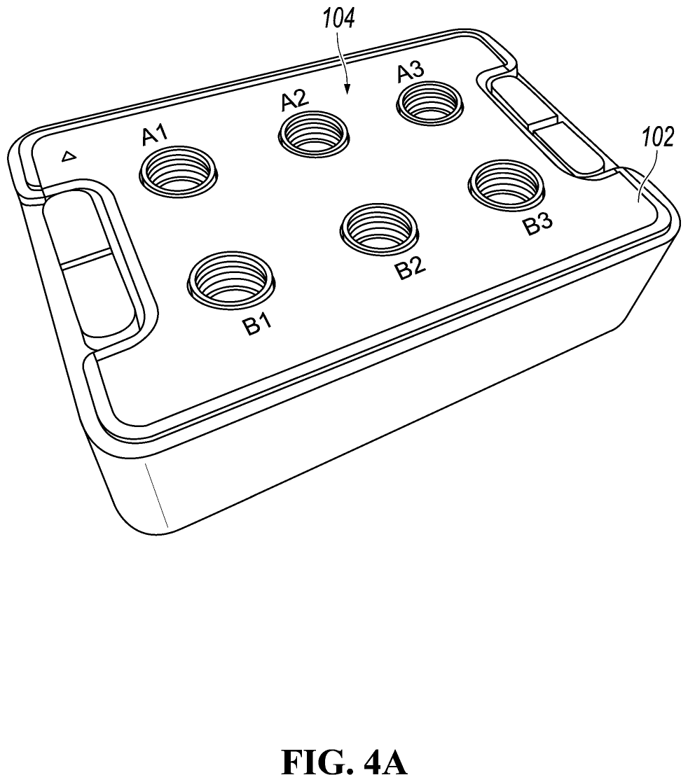

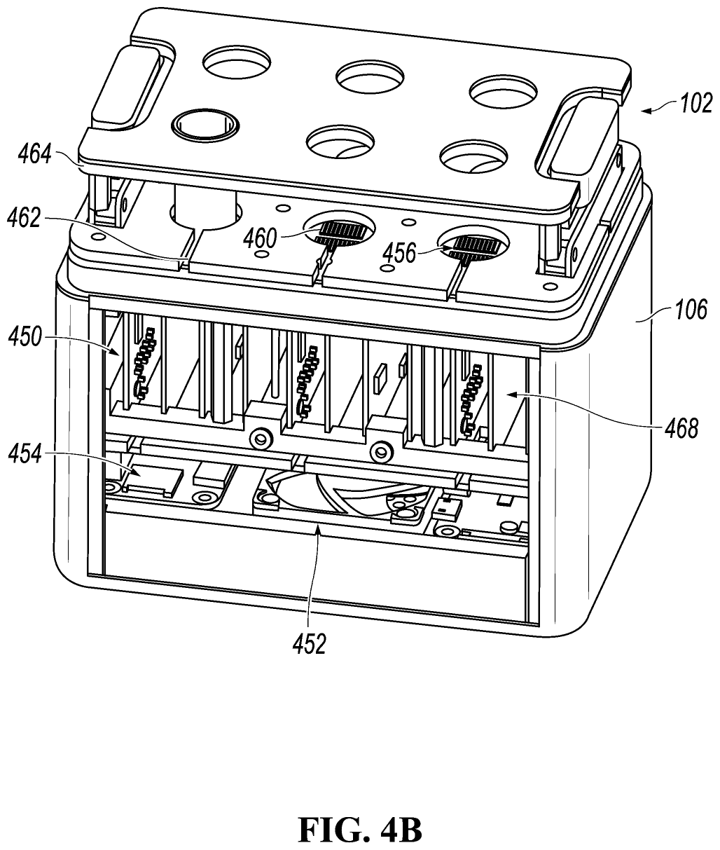

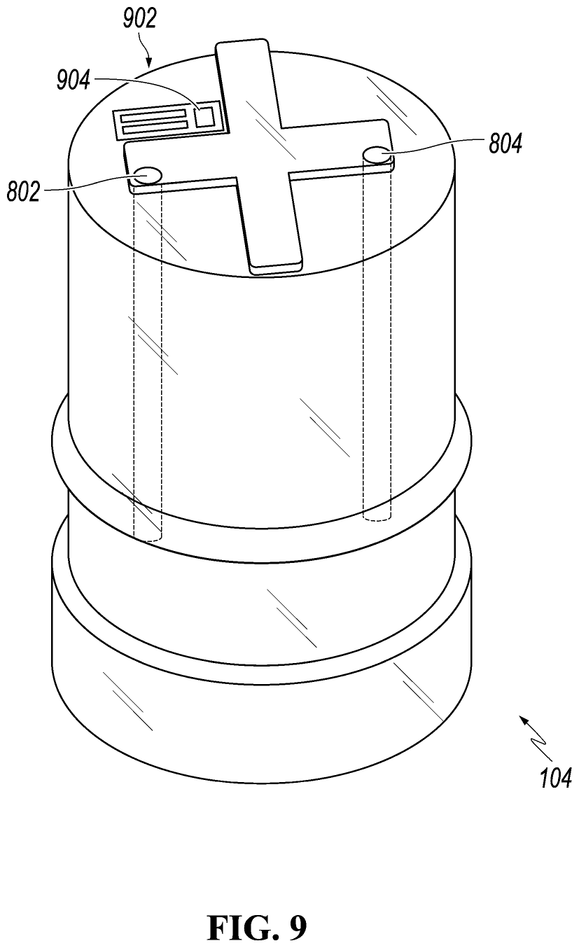

FIG. 3 is a perspective view of an example modular analyte system base 106. The base 106 houses electrochemical instrumentation 450 (FIG. 4B) that is configured to scan voltage biases applied to a sensor 904 (FIG. 9) on the well 104 (FIG. 1) with respect to a first electrode 902 in each sample well 104. The applied bias is regulated by a second electrode 802 also in the sample well 104. Details on such a process are described within US patent number 111,035,810, the entirety of which is incorporated by reference herein. The instrumentation 450 provides feedback regulation of the bias applied between the sensor 904 and first electrode 804 by supplying current through the second electrode 802 to maintain the bias to a desired set point. The instrumentation 450 also measures the supplied current and provides the means to apply a desired bias to a shield electrode around the sensing interface to mitigate stray parasitic capacitances. To support measurement on all of the wells 104 simultaneously, the base 106 can hold individual printed circuit boards for each well 104 that perform the feedback regulation and current measurement in one implementation. In some implementations, the feedback regulation and current measurement circuits can be integrated on a single board. In some implementations, the different biases applied to sensors are sourced from a voltage reference integrated circuit.

The base can include heat sinks 468 and insulation to reduce heating of sample wells 104 from power dissipated by base electronics. Alternatively or in addition, a fan 452 is affixed to the base 106 to provide forced convective cooling of base 106. A housing of the base 106 chassis defines an array of holes to facilitate air circulation to cool system to desired specification to enable temperature-proof operation of the measurement. In some implementations, the base 106 houses temperature sensors at multiple locations to record ambient temperature during measurement. The base 106 can include electrical shields to protect sensitive electrical measurements from being corrupted by stray electrical interferences from the ambient environment or adjacent circuitry. Alternatively or in addition, the base 106 includes accelerometers to monitor mechanical shocks to the instrument during measurement. Such accelerometers can be used to measure physical acceleration (rapid motion), and produce a record of mechanical shocks to the instrument chassis to assess measurement integrity.

In some implementations, the base 106 is powered from a standard electrical outlet (e.g., a 120 volt or 240 volt outlet). In some implementations, a voltage converter (e.g., a transformer, a voltage divider) can be include. Regardless, the power is received by a power port 302. Alternatively or in addition, the base 106 can include a battery. The base 106 is configured to be connected to the internet, for example, through an Ethernet or universal serial bus (USB) port 304. In some implementations, the base 106 includes a wireless antenna configured to allow the base 106 to connect to the internet by a wireless network.

In operation, the controller 454 within the base 106 directs a voltage bias signal to the sensor interface 456, for example, by the board 450, relative to the first electrode 804, and to a shield that surrounds the sensor interface 456. In addition, a regulating voltage signal is applied, as directed by the controller 454, for example, by the board 450, to the second electrode 802 in the well. These signals are passed between the base 106 and the cartridge 102 by the receptacle 202 and pins 204, for all of the wells 104. Signals from one or more temperature sensors in the cartridge 102 are also routed to the controller 454 by the receptacle 202 and pins 204.

FIG. 4A is a top perspective view of an example modular analyte system cartridge 102. Sample wells 104 are secured with cavities on the cartridge 102, with the help of guidance features embossed on the outer edges of the well 104, to keep the well 104 aligned with spring-loaded electrical connectors 460 in the cartridge receptacle 202. Mechanical or magnetic hold down mechanisms 464 apply vertical pressure to keep the well sensors 904 in good electrical contact with the spring-loaded connectors 460. Connectors allow for the application of sensor-to-first electrode bias, shield bias, current regulation signal at second electrode 802. In some implementations, all of the sample wells 104 are identical to each other. In some implementations each sample well includes one to four integrated sensors. In some implementations, the sample wells 104 can have different configurations, for example, different sample wells can include a different number of sensors.

FIG. 4B is a perspective views of internals of the analyte system 100. In some implementations, spring connectors 460 within the cartridge 102 facilitate electrical connection between the sensor(s) 904 on each well 104 and a printed circuit board 462 within the cartridge 102. The circuit board 462 is configured to carry and/or direct the multiplicity of signals from the wells to the underlying base.

In some implementations, the cartridge 102 includes a memory that holds a unique identifier for the cartridge 102, and, in some implementations, for the wells 104 associated with the cartridge 102. Such details are written to the cartridge memory 502 during assembly of the cartridge 102. Once a scan is performed on a sample in a well 104, the cartridge memory 502 can also record that the well 104 has been used in a measurement. Alternatively or in addition, such recordation can be recorded to a database coupled to or associated with a cloud service 1102.

In some implementations, the cartridge 102 includes heat sinks and/or insulation panels to insulate the wells 104 from heat sources. In some implementations, electrical shielding is also incorporated to prevent electromagnetic interference from corrupting measurements made in wells 104.

FIG. 5 is a top-up view of an example modular analyte system cartridge 102. The pins 204 extend perpendicular form a lower surface 504 of the cartridge 102 to interface with the receptacle 202 of the base 106 as previously described. The pins are coupled to the various electrodes (902, 802, 804) within the various wells 104. In some implementations, additional pins can be used for power and data transfer, for example data indicative of a fit-for-use state of reach well 104. In some implementations, the pins can be coupled to the cartridge memory, and the base 106 is able to read and/or write to the cartridge memory 502.

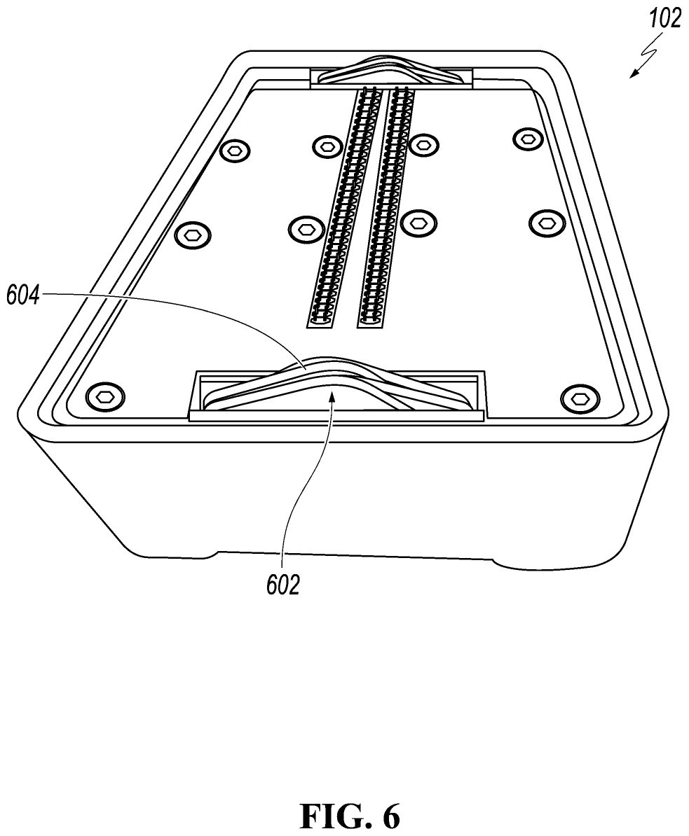

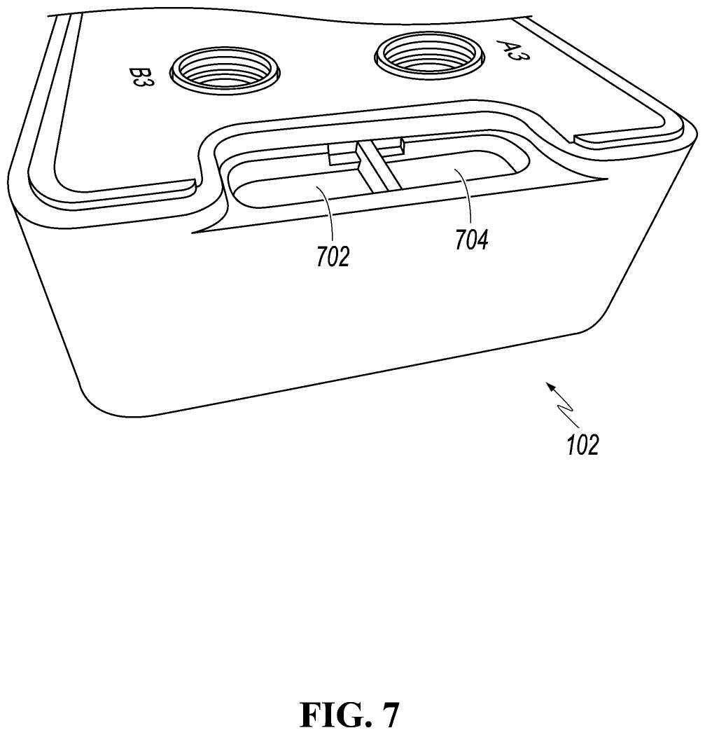

FIG. 6 is a bottom perspective view of an example modular analyte system cartridge 102. FIG. 7 is a side perspective view of the example modular analyte system cartridge 102. In some implementations, the cartridge 102 is locked to the base 106 once the base is received. The cartridge 102 can be locked to the base 106 with a variety of interlocks, for example, mechanical, electronic, pneumatic, and/or magnetic interlocks can be used without departing from this disclosure. As the cartridge 102 can be locked to the base 106, and the cartridge 102 sits flush to the base 106, removing the cartridge 102 from the base 106 without assistance can be difficult. As such, in some implementations, the cartridge includes a rocking linkage 602 configured to separate the cartridge 102 from the base 106. The rocking linkage is arranged to exert pressure at an interface 604 as the user alternates pressing a first button 702 and a second button 704 coupled to different ends of the rocking linkage 602.

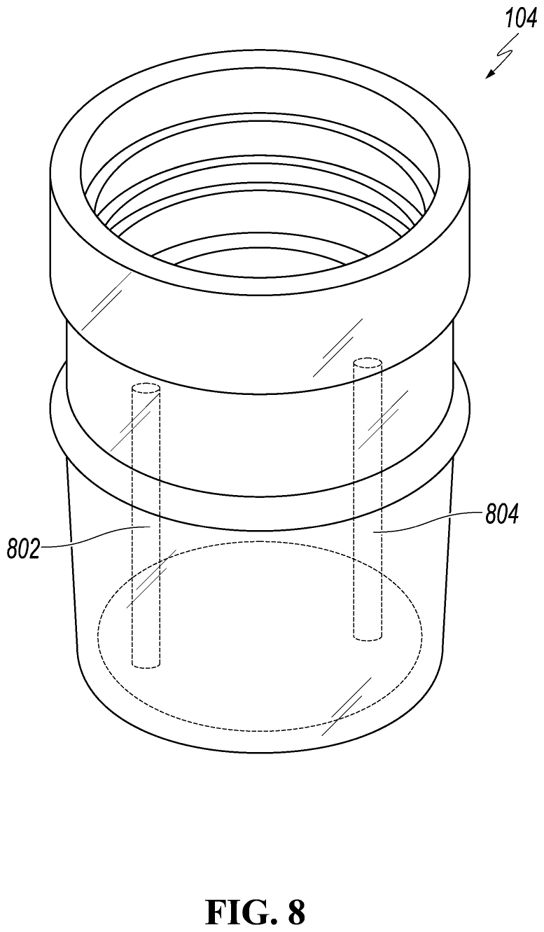

FIG. 8 is a top perspective view of an example sample well 104, and FIG. 9 is a bottom perspective view of the example well 104 with a single sensor 904. The second electrode 802 and the third electrode 804, in some implementations are gold coated metallic pins that are conductively coupled to the spring connectors 460 (FIG. 4B) within the cartridge 102. In some implementations, such electrodes (802, 804) are inserted into the plastic well 104 during or after the molding of the sample well 104.

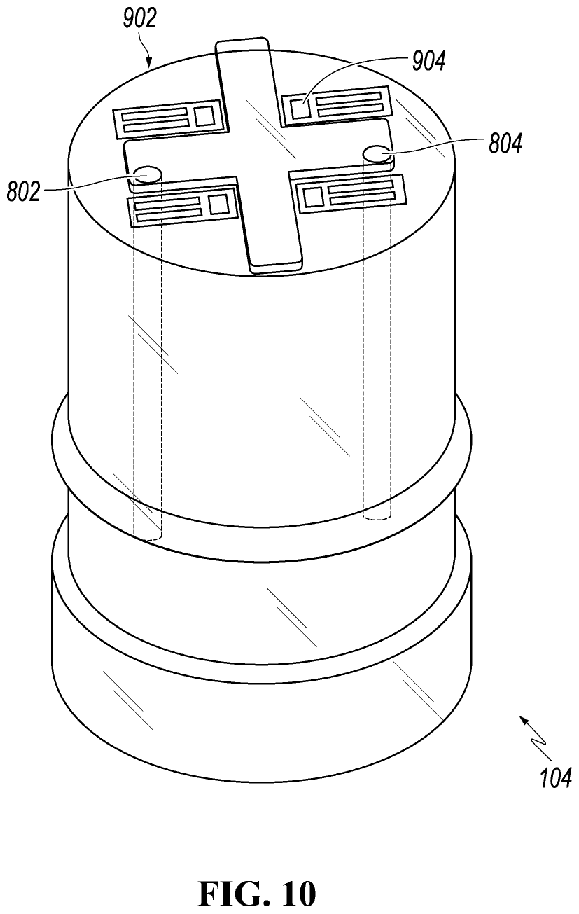

FIG. 10 is a bottom perspective view of an example well 104 with multiple sensors 904. In some implementations, multiple (e.g., 2-4) first electrodes 902 can be coupled to the sample well 104. Each first electrode 902 includes a metal nanoelectrode and accompanying shield electrode patterned on a silicon die, where the silicon die is affixed to a flexible substrate via a conductive glue layer. Each first electrode constitutes a different sensor, where the metal nanoelectrodes are functionalized by different surface chemistries on the nanoelectrode-electrolyte interface and/or different charges induced by the bias applied on the shield electrode.

FIG. 11 is a diagram showing the communications between the modular analyte system 100, a cloud service 1102, and a local computer 1104. The modular analyte system is capable of communicating with both a local computer 1104 and a cloud service 1102, for example through an Ethernet port, a USB port, or a wireless connection, such as Wi-Fi or Bluetooth. For example, in some implementations, the modular analyte system 100 is coupled to the local computer during initial set-up, and communicates directly with the cloud service 1102 for subsequent operations. In such implementations, the local computer 1104 can be used to access data stored on the cloud service 1102, for example test results or details on the cartridge 102. Alternatively or in addition, the analyte sensing system 100 can be pre-configured such that the analyte sensing system 100 does not interface directly with the local computer 1104 and instead solely communicates with the cloud service 1102. Alternatively or in addition, in some implementations, the analyte sensing system 100 can communicate solely with the local computer 1104. Such arrangements may be used, for example in locations with unreliable internet connections or in situations where an air-gapped local computer is necessary.

FIG. 12 illustrates an example controller 110 that can be used with aspects of this disclosure. The controller 454 can, among other things, monitor parameters of the system 100 send signals to actuate and/or adjust various operating parameters of such systems. As shown in FIG. 12, the controller 454 can include one or more processors 1250 and non-transitory computer readable memory storage (e.g., memory 1252) containing instructions that cause the processors 1250 to perform operations described herein. The processors 1250 are coupled to an input/output (I/O) interface 1254 for sending and receiving communications with components in the system, including, for example, the board(s) 450. In some implementations, the controller 454 communicates instructions to the board(s) 450, and the boards execute the instructions. In certain instances, the controller 454 can additionally communicate status with and send actuation and/or control signals to one or more of the various system components (including, for example, the computer 1104 or the cloud service 1102) of the system 100, as well as other sensors (e.g., temperature sensors, vibration sensors and other types of sensors) that provide signals to the system 100.

The controller can be located in a variety of places within the system 100. For example, the controller 454 can be located within the base 106, the cartridge 102, or can be distributed so parts of the controller 454 are within different locations. Alternatively or in addition, multiple networked controllers 454 can be used, for example, the cartridge can include a cartridge controller and the base can include a base controller. In such implementations, the separate controllers can network together to act as a singular controller. Alternatively or in addition, multiple controllers can be included in the base 106, the cartridge 102, or both. In implementations with multiple controllers, the controller can be used for specialized tasks and can communicate with one another to execute the action described throughout this disclosure.

In operation, the controller 454 identifies each sample well 104 of the cartridge 102 and determines a status of each sample well 104. Once a sample has been added to a selected sample well, the controller then directs an analysis of a substance to be performed within the selected sample well. A spectrum is produced based on the performed analysis, and the spectrum is uploaded, for example, to the cloud service 1102. The presence of a target analyte is then determined based on the produced spectrum, in some implementations, by the controller.

In some implementations, the controller 454 within the base 106 includes a buffer memory and is configured to control the individual feedback regulations in response to specific commands provided by the user via a programmable user interface that get communicated to the base via a secure connection to the cloud service 1102. In addition, the controller 454 performs basic calibration tasks to correct drift and other errors in the measured current and voltage at the sensor interface.

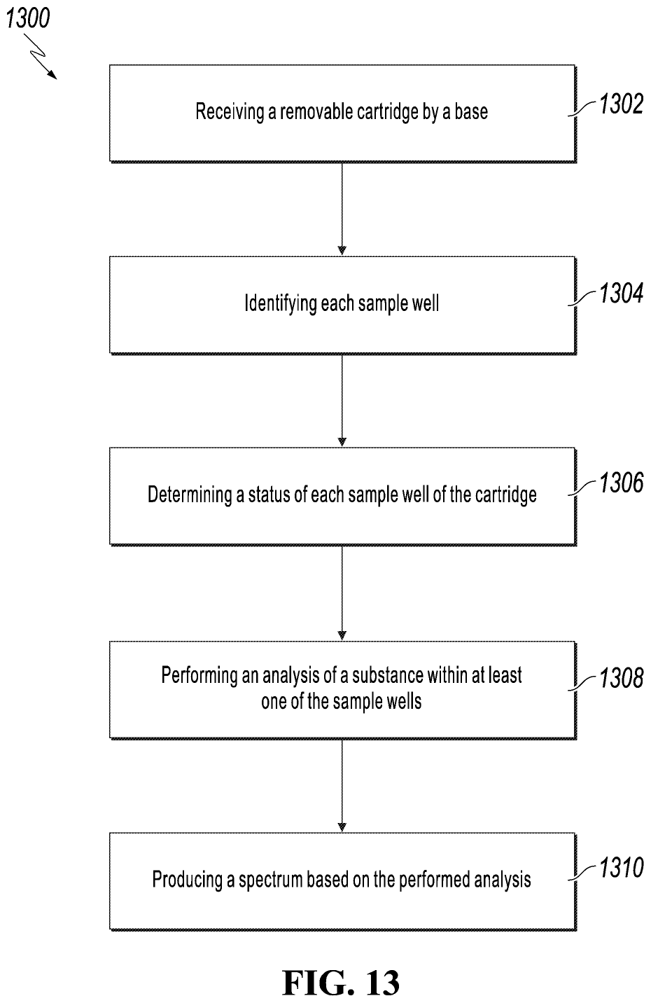

FIG. 13 is a flowchart of an example method 1300 that can be used with aspects of this disclosure. At 1302, the removable cartridge 102 is received by the base 106, the cartridge comprising a plurality of sample wells. At 1304, each sample well 104 of the cartridge 102 is identified, for example by the controller 454 within the base 106, the local computer 1104, or the cloud service 1102.

At 1306, a status of each sample well of the cartridge is determined. Determining the status of each cartridge involves looking up a usage history of each identified sample well 104 and determining a fit-for-use status of each sample well 104. In some implementations, the fit-for-use status for each sample well 104 is determined based a date when the sample well 104 was last used, and a date when the sample well 104 was last serviced. For example, in instances where the sample well 104 has been used since the last service, the sample well 104 would be deemed as “not usable”, and in instances where the sample well 104 has not be used since the last service would be deemed as “usable”. Such information can be determined, for example, by querying such information in a look-up table. In some implementations, such as when the sample wells 104 are manufactured as a consumable item, determining if the sample well 104 has been used or not is sufficient to make a fit-for-service determination. In instances when the fit-for-use status indicates that the sample well is not usable, the sample well is locked-out from analysis operations. That is, any fluid sample added to the locked-out sample well is not analyzed due to an interlock, such as a software interlock, or visual feedback provided to the user via a programmable user interface on a local computing device will inform the user that they should not aliquot precious sample into the unusable well. In instances when the fit-for-use status indicates that the sample well is usable the sample well is enabled for analysis operations.

At 1308, an analysis of a substance within at least one of the sample wells is performed. In some implementations, at the end of the analysis in 1308, user is provided with feedback on whether the scan generates good quality data suitable for use in detection of targets. If the scan does not generate usable data, then the user is prompted to scan the sample in a new well via a programmable user interface on a local computing device. At 1310, producing a spectrum based on the performed analysis. The presence of a target analyte is then determined based on the produced spectrum. In some implementations, a reference spectrum has been previously produced from a reference sample known to contain the target analyte. In such implementations, comparing the produced spectrum to the reference spectrum is used to help determine the presence of the target analyte. Spectrums, such as the determined spectrum or the reference spectrum, can be stored locally within the base 106, locally on a computer, or uploaded and stored to a cloud service.

After the sample wells 104 within the cartridge have been used, the cartridge 102 is then serviced. In some implementations, servicing the cartridge 102 involve replacing the sample wells 104 within the cartridge 102, cleaning the sample wells 104 within the cartridge 102, or a combination of such options.

### Definitions

Unless otherwise defined, all terms of art, notations and other scientific terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

The singular form “a”, “an”, and “the” include plural references unless the context clearly dictates otherwise. For example, the term “a cell” includes one or more cells, including mixtures thereof. “A and/or B” is used herein to include all of the following alternatives: “A”, “B”, “A or B”, and “A and B”.

It is understood that aspects and implementations of the disclosure described herein include “comprising”, “consisting”, and “consisting essentially of” aspects and implementations.

As used herein, “comprising” is synonymous with “including”, “containing”, or “characterized by”, and is inclusive or open-ended and does not exclude additional, unrecited elements or method steps. Any recitation herein of the term “comprising”, particularly in a description of components of a composition or in a description of steps of a method, is understood to encompass those compositions and methods consisting essentially of and consisting of the recited components or steps. As used herein, “consisting of” excludes any elements, steps, or ingredients not specified in the claimed composition or method. As used herein, “consisting essentially of” does not exclude materials or steps that do not materially affect the basic and novel characteristics of the claimed composition or method.

Where a range of values is provided, it is understood by one having ordinary skill in the art that all ranges disclosed herein encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as dis-cussed above. As will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number. If the degree of approximation is not otherwise clear from the context, “about” means either within plus or minus 10% of the provided value, or rounded to the nearest significant figure, in all cases inclusive of the provided value.

Headings, e.g., (a), (b), (i) etc., are presented merely for ease of reading the specification and claims. The use of headings in the specification or claims does not require the steps or elements be performed in alphabetical or numerical order or the order in which they are presented.

It is appreciated that certain features of the disclosure, which are, for clarity, described in the context of separate implementations, may also be provided in combination in a single implementation. Conversely, various features of the disclosure, which are, for brevity, described in the context of a single implementation, may also be provided separately or in any suitable sub-combination. All combinations of the implementations pertaining to the disclosure are specifically embraced by the present disclosure and are disclosed herein just as if each and every combination was individually and explicitly disclosed. In addition, all sub-combinations of the various implementations and elements thereof are also specifically embraced by the present disclosure and are disclosed herein just as if each and every such sub-combination was individually and explicitly disclosed herein.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

What is claimed is:

1. An analyte sensing system comprising:
a removable cartridge comprising a plurality of sample wells, each configured to receive a sample fluid for analysis; and
a base configured to receive the cartridge, the base configured to send and receive signals to the cartridge when the cartridge is received by the base.

2. The analyte sensing system of claim 1, wherein each of the plurality of sample wells comprising a sensor comprising:
a first electrode arranged to contact the sample fluid;
a second electrode arranged to contact the sample fluid; and
a third electrode arranged to contact the sample fluid.

3. The analyte sensing system of claim 2, wherein the base comprises:
a receptacle configured to receive a plurality of electrical pins coupled to the first electrode, the second electrode, and the third electrode; and
a controller coupled to the receptacle, the controller configured to direct an exchange of signals with the first electrode, the second electrode, and the third electrode by the receptacle and pins.

4. The analyte sensing system of claim 3, wherein the controller is configured to:
identify each sample well of the plurality of sample wells of the cartridge;
determine a status of each sample well of the cartridge;
direct an analysis of a substance within at least one of the sample wells to be performed; and
produce a spectrum based on the performed analysis.

5. The analyte sensing system of claim 4, wherein the controller is further configured to determine a presence of a target analyte based on the produced spectrum.

6. The analyte sensing system of claim 4, wherein the controller is further configured to upload the produced spectrum to a cloud service.

7. The analyte sensing system of claim 1, wherein the cartridge comprises:
a rocking linkage configured to separate the cartridge from the base.

8. A method comprising:
receiving a removable cartridge by a base, the cartridge comprising a plurality of sample wells;
identifying each sample well of the plurality of sample wells of the cartridge;
determining a status of each sample well of the cartridge;
performing an analysis of a substance within at least one of the sample wells; and
producing a spectrum based on the performed analysis.

9. The method of claim 8, wherein determining the status comprises:
determining an identification of the sample well;
looking up a usage history of the sample well; and
determining a fit-for-use status of the sample well.

10. The method of claim 9, wherein the fit-for-use status is determined based on criteria comprising:
a date when the sample well was last used; and
a date when the sample well was last serviced.

11. The method of claim 9, wherein looking up a usage history comprises querying a look-up table.

12. The method of claim 9 wherein the fit-for-use status indicates that the sample well is not usable, the method further comprising:
locking-out the sample well from analysis operations.

13. The method of claim 9, wherein the fit-for-use status indicates that the sample well is usable, the method further comprising:
enabling the sample well for analysis operations.

14. The method of claim 8 further comprising servicing the cartridge.

15. The method of claim 14, wherein servicing the cartridge comprises:
replacing the plurality of sample wells; or
cleaning the sample wells.

16. The method of claim 8, further comprising determining a presence of a target analyte based on the produced spectrum.

17. The method of claim 16, wherein determining a presence of a target analyte based on the produces spectrum comprises:
generating a reference spectrum from a reference sample; and
comparing the produced spectrum against the reference spectrum.

18. The method of claim 8, further comprising uploading the produced spectrum to a cloud service.

19. An analyte sensing system comprising:
a removable cartridge configured to receive one or more fluid sample for analysis, wherein the cartridge comprises a plurality of sample wells, each of the plurality of sample wells comprising a sensor comprising:
a first electrode arranged to contact the sample fluid;
a second electrode arranged to contact the sample fluid; and
a third electrode arranged to contact the sample fluid; and
a base configured to receive the cartridge, the base configured to send and receive signals to the cartridge when the cartridge is received by the base, wherein the base comprises:
a receptacle configured to receive a plurality of electrical pins coupled to the first electrode, the second electrode, and the third electrode; and
a controller coupled to the receptacle, the controller configured to direct an exchange of signals with the first electrode, the second electrode, and the third electrode by the receptacle and the pins, the controller configured to:
identify each sample well of the plurality of sample wells of the cartridge;
determine a status of each sample well of the cartridge;
direct an analysis of a substance within at least one of the sample wells to be performed;
produce a spectrum based on the performed analysis; and
determining a presence of a target analyte based on the produced spectrum.

20. The analyte sensing system of claim 19, wherein the controller is further configured to upload the produced spectrum to a cloud service.
